(19) United States
(12) Patent Application Publication
(10) Pub. No.: US 2008/0290041 A1
(43) Pub. Date: Nov. 27, 2008

(54) METHODS AND APPARATUS FOR EFFICIENT OPERATION OF AN ABATEMENT SYSTEM

(75) Inventors: Daniel O. Clark, Pleasanton, CA (US); Robbert M. Vermeulen, Pleasant Hill, CA (US); Youssef A. Loldj, Sunnyvale, CA (US); Belynda Flippo, Capitola, CA (US); Mehran Moalem, Cupertino, CA (US); Shaun W. Crawford, San Ramon, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/126,920

(22) Filed: May 25, 2008

Related U.S. Application Data
(60) Provisional application No. 60/931,731, filed on May 25, 2007.

(51) Int. Cl. G05B 11/00

(52) U.S. Cl. 210/741; 210/739; 210/742; 210/103; 210/85

(57) ABSTRACT

A method of operating an electronic device manufacturing system is provided which includes the steps of receiving information with an interface, wherein the information relates to an abatement system, and shutting down a process tool and an abatement tool in response to the information.

The present application claims priority to U.S. Provisional Patent Application Ser. No. 60/931,731, filed May 25, 2007 and entitled “Methods and Apparatus for Abating Effluent Gases Using Modular Treatment Components” (Attorney Docket No. 12073/L), which is hereby incorporated herein by reference in its entirety for all purposes.

### CROSS-REFERENCE TO RELATED APPLICATIONS

Co-owned U.S. patent application Ser. No. 11/686,005, filed Mar. 14, 2007 and entitled “METHOD AND APPARATUS FOR IMPROVED OPERATION OF AN ABATEMENT SYSTEM” (Attorney Docket No. 9139), is hereby incorporated by reference herein in its entirety and for all purposes.

### FIELD OF THE INVENTION

The invention relates generally to electronic device manufacturing systems, and more specifically to methods and apparatus for efficient operation of an abatement system.

### BACKGROUND OF THE INVENTION

Electronic device manufacturing process tools (hereinafter “process tools”) conventionally employ chambers or other suitable apparatus adapted to perform processes (e.g., chemical vapor deposition, epitaxial silicon growth, and etch, etc.) to manufacture electronic devices. Such processes may produce effluents having undesirable, harmful and/or dangerous chemicals as by-products of the processes. Conventional electronic device manufacturing systems may use abatement apparatus to treat or abate the effluents.

Conventional abatement tools and processes employ a variety of resources (e.g., fuel, reagents, water, and electricity, etc.) to treat the effluents. Such abatement tools typically operate with little information about the effluents being treated by the abatement tools. Accordingly, conventional abatement tools may sub-optimally use the resources. Sub-optimal use of the resources may be an undesirable cost burden in a production facility. In addition, more frequent maintenance may be required for abatement tools that do not use resources optimally.

Accordingly, a need exists for improved methods and apparatus for abating effluents.

### SUMMARY OF THE INVENTION

In a first aspect, a method of operating an electronic device manufacturing system is provided, including the steps of receiving information with an interface, wherein the information relates to an abatement system; and shutting down a process tool and an abatement tool in response to the information.

In a second aspect, a method of operating an electronic device manufacturing system is provided, which includes the steps of receiving information with an interface, wherein the information relates to an electronic device process tool; and placing an abatement tool in an idle mode in response to the information.

In a third aspect, an electronic device manufacturing system is provided, including 1) an electronic device manufacturing process tool; 2) an abatement tool adapted to abate effluent from the electronic device manufacturing process tool; 3) a resource supply adapted to supply a resource to the abatement tool; 4) a sensor adapted to measure at least one of a flow of the resource to the abatement tool and an operating parameter of the abatement tool; and 5) an interface adapted to receive information from the flow sensor, wherein the information comprises a rate of flow of the resource.

Numerous other aspects are provided in accordance with these and other aspects of the invention. Other features and aspects of the present invention will become more fully apparent from the following detailed description, the appended claims and the accompanying drawings.

### BRIEF DESCRIPTION OF THE DRAWINGS

FIG. 1 is a schematic drawing depicting an electronic device manufacturing system having an electronic device manufacturing tool, a pump, an interface, and an abatement system in accordance with the present invention.

FIG. 2 is a flowchart depicting a method of operating an electronic device manufacturing system in accordance with an embodiment of the present invention.

FIG. 3 is a flowchart depicting a second method of operating an electronic device manufacturing system in accordance with an embodiment of the present invention.

### DETAILED DESCRIPTION

As described above, abatement tools typically operate with little information regarding effluent which is being produced by a process tool. As such, abatement tools may typically be operated in a single mode which enables the abatement tool to abate a worst-case effluent load (referred to herein as a “worst-case mode”). The effluent flow from a process tool, however, may not be a constant flow of a uniform chemical composition. Instead, the effluent flow may range from a zero effluent flow to a worst-case effluent flow, with chemical compositions which vary as well. The net effect of operating an abatement tool in a single, worst-case mode may be that abatement resources, including fuel, reagents, and/or cooling medium, are wasted. The present invention addresses this and other shortcomings.

In one embodiment, the present invention provides an abatement tool which may be operated in different modes depending upon the nature and effluent flow rate from a process tool. Thus, for example, when the process tool is producing a large effluent flow, the abatement tool may be operated in a “high mode”; when the process tool is producing a medium effluent flow, the abatement tool may be operated in a “medium mode”; and when the process tool is producing a low effluent flow, the abatement tool may be operated in a “low mode”. In addition, if the process tool is producing no effluent, the abatement tool may be operated in an “idle mode”. This selection of operating mode based upon the actual rate of flow and nature of effluent flowing from a process tool may result in the use of fewer abatement resources when fewer abatement resources are needed to abate the actual effluent flow.

In some embodiments, the operating mode of the abatement tool may be selected based on foreknowledge of the nature and effluent flow rate from the process tool at any particular time. This foreknowledge may be in the form of a schedule or pattern of known processes which are performed in process chambers of the process tool. When the number and type of processes are known, the amount and nature of effluent may be predicted.

In other embodiments, the operating mode of the abatement tool may be selected based on a real-time measurement of effluent makeup and flow rate.

Even though an abatement tool may be operating in a mode which has been selected based upon the flow rate and/or chemical make up of effluent to provide optimal abatement resource use pursuant to the present invention, it may be possible that the abatement tool may become starved for an abatement resource such as fuel, reagent, and/or cooling medium. By “starved” is meant that the abatement tool is not receiving the amount of fuel, reagent, and/or cooling medium that is required to run in a selected mode. In such a circumstance, the effluent may not be fully abated, or a dangerous condition may be created. In some embodiments, therefore, the present invention provides flow meters to measure the flow of fuel, reagent, and cooling medium. Upon determining that the flow of fuel, reagent, and/or cooling medium is insufficient for the selected mode, the present invention may provide for sending an alarm and/or instructing the process tool to shut down.

It may also be possible for an abatement tool to receive too much of an abatement resource such as fuel, reagent, and/or cooling medium. Upon determining that the flow of fuel, reagent, and/or cooling medium is too great for the selected mode, the present invention may provide for sending an alarm and/or instructing the process tool to shut down.

Similarly, it is possible for the abatement tool to receive an effluent from the process tool that the abatement tool is not expecting and which may cause the abatement tool to operate outside of its design parameters. In some embodiments, therefore, the present invention provides sensors adapted to sense whether the abatement tool is operating outside of its design parameters, and, if it is, an interface or controller may issue a warning and/or command the process tool to shut down to prevent damage to the abatement tool and/or personnel.

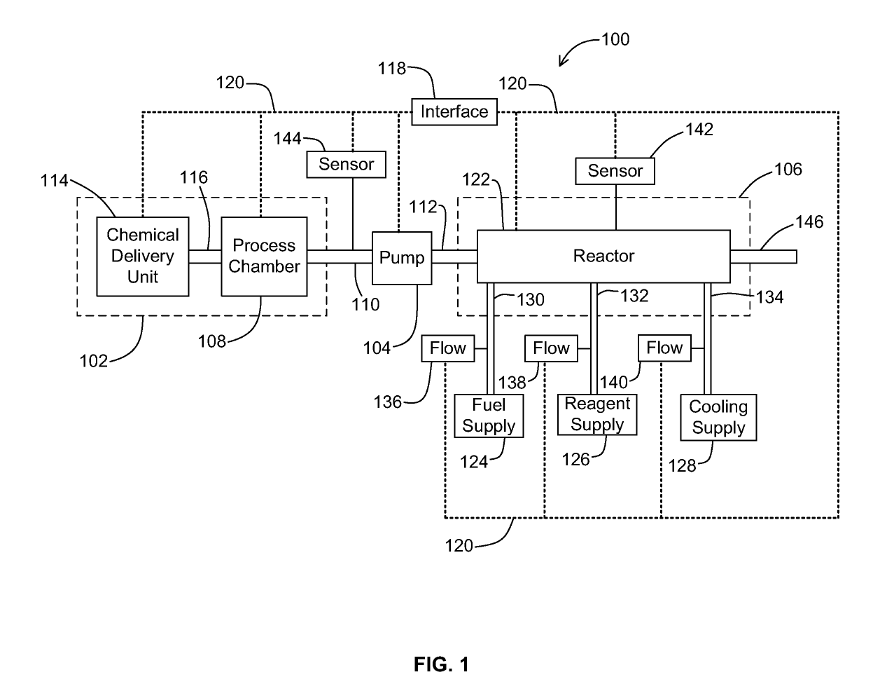

FIG. 1 is a schematic drawing depicting an electronic device manufacturing system 100 in accordance with the present invention. The electronic device manufacturing system 100 may include an electronic device manufacturing tool or process tool 102, a pump 104, and an abatement system 106. The electronic device manufacturing tool 102 may have a process chamber 108. The process chamber 108 may be coupled to the abatement system 106 via a vacuum line 110. The pump 104 may be coupled to the abatement system 106 via a conduit 112. The process chamber 108 may also be coupled to a chemical delivery unit 114 via a fluid line 116. An interface 118 may be coupled to the process chamber 108, the chemical delivery unit 114, the pump 104, and the abatement system 106 via signal lines 120.

The interface 118 may be a microcomputer, microprocessor, logic circuit, a combination of hardware and software, or the like, suitable to receive information about the process tool and the abatement tool, and to transmit information about, and/or commands to, the process tool and the abatement tool. The interface 118 may be adapted to perform and may perform the functions of a system controller, or may be separate from the system controller.

The abatement system 106 may include a reactor 122 that may be coupled to a power/fuel supply 124, a reagent supply 126, and a cooling supply 128. The fuel supply 124, the reagent supply 126, and the coolant supply 128, may be connected to the reactor 122 by fuel conduit 130, reagent conduit 132 and cooling conduit 134. Flowmeters 136, 138, 140 may be connected to fuel conduit 130, reagent conduit 132 and cooling conduit 134, respectively. Flowmeters 136, 138, 140 may be coupled to the interface 118 by signal lines 120. Any suitable flowmeters may be used. Sensor 142 may be coupled to reactor 122 and also to interface 118 by signal line 120. Sensor 144 may be coupled to vacuum line 110 and also coupled to interface 118 by signal line 120. Reactor 122 may be connected to conduit 146.

In operation, the electronic device manufacturing tool 102 may be adapted to perform, and may perform, various processes to manufacture (e.g., fabricate) electronic devices. The processes may be performed in the process chamber 108 at a pressure less than an ambient pressure (e.g., about one atmosphere (atm), etc.). For example, some processes may be performed at pressures of about 8 to 700 milli-torr (mTorr), although other pressures may be used. To achieve such pressures the pump 104 may remove the effluent (e.g., gas, plasma, etc.) from the process chamber 108. The effluent may be carried by the vacuum line 110.

Chemical precursors (e.g., SiH₄, NF₃, CF₄, BCl₃, etc.) of the effluent being removed by the pump 104 may be added to the process chamber 108 by a variety of means. For example, the chemical precursors may be flowed to the process chamber 108 via the fluid line 116 from the chemical delivery unit 114. In addition, the chemical delivery unit 114 may be adapted to provide, and may provide, information (e.g., pressure, chemical composition, flow rate, etc.), via the signal lines 120, related to the chemical precursors provided by the chemical delivery unit 114.

The interface 118 may be adapted to and may receive information from various subsystems of the electronic device manufacturing system 100. For example, the interface 118 may receive information related to processes being performed in the process chamber 108. The information may include process information (e.g., process step time, pressure, fluid flows, etc.) and may be provided by a sensor, controller or other suitable apparatus. The interface 118 may use such information to determine or predict additional information such as, for example, parameters of the effluent.

The interface 118 may also receive information related to the abatement of effluent from the reactor 122. The information may include abatement information such as, for example, temperature, pressure, humidity, flow, electrical power, presence of flame, etc. and may be provided by a sensor 142, controller or other suitable apparatus.

The interface may also receive information related to the effluent flowing through vacuum line 110 such as, for example, composition and flow, etc. and may be provided by a sensor 144, controller or other suitable apparatus.

In addition, the interface 118 may receive information related to the flow rates of fuel, reagent, and coolant, from flowmeters 136, 138, 140, respectively.

The interface 118 may provide the information related to the effluent to the abatement system 106. Such information may be employed to adjust parameters of the abatement system 106. The interface may also provide information related to the abatement of effluent to the process tool 102. Such information may be used to adjust parameters of the process tool 102.

The interface 118 may also be adapted to issue commands to both the process tool 102, the pump 104 and the abatement tool 106. Such commands may be transmitted by signal lines 120, or wirelessly.

The effluent may be carried by the vacuum line 110 from the process chamber 108 to the abatement system 106. The pump 104 may remove the effluent from the process chamber 108 and move the effluent to the abatement system 106. The abatement system 106 may be adapted to attenuate the undesirable, dangerous or hazardous material in the effluent using the fuel supply 124, reagent supply 126, and/or cooling supply 128.

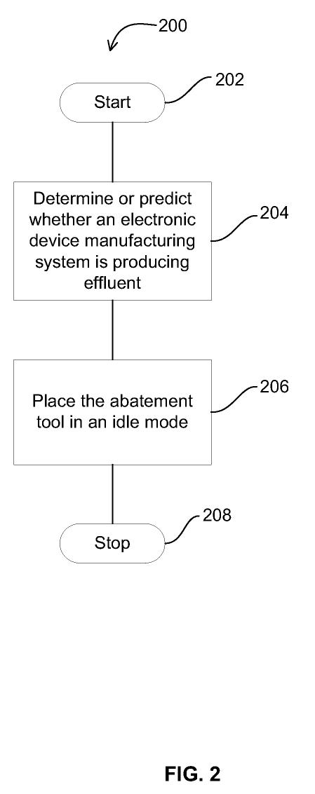

FIG. 2 is a flowchart depicting a method of adjusting an electronic device manufacturing system in accordance with the present invention. The method 200 begins with step 202.

In step 204, interface 118 or other suitable apparatus may determine whether the process tool 102 is producing effluent. For example, interface 118 may receive a signal from sensor 144 which indicates that effluent is not flowing through vacuum line 144. Alternatively, interface 118 may receive a signal from process tool 102 which indicates that process chamber 108 is not producing effluent and will not be producing effluent for a period of time. In yet another embodiment, interface 118 may receive information from a database which indicates that process chamber 108 is not producing effluent at that time. For example the database may have a schedule of process steps being performed by process tool 102, and may therefore be able to indicate to the interface 118 the times at which the process tool will not be producing effluent. The database may also be programmed with the period of time during which the process tool will not be producing effluent, and may provide this information to the interface 118.

In step 206 abatement tool 106 may be placed in an idle mode in response to the information received by the interface. This step may be effected by the interface 118 which may issue a command, or instructions, which places the abatement tool 106 in the idle mode. In one embodiment, idle mode may include shutting off burner jet fuel flow, but leaving a pilot flame alight and keeping a sufficient flow of oxidant to enable the pilot flame to burn and a sufficient flow of water or other cooling medium to prevent the abatement tool 106 from overheating. Other configurations are possible.

There are numerous conditions which may warrant placing an abatement tool 106 in an idle mode. Examples include: the process tool performing a long process step during which time no effluent is produced; a process tool has been taken out of service for maintenance or troubleshooting; and a process tool or factory is about to undergo startup. An abatement tool 106 which is in idle mode may be brought to an operational mode within a short period of time, e.g., within about two to about five seconds, or about three seconds. Thus, at any time when the operator or controller becomes aware of a period of time longer than about two to about five seconds where no effluent will be produced by a process tool, the operator or controller may place the abatement tool 106 in idle mode.

In an optional step (not shown), at a time when the abatement tool 106 is in the idle mode, the interface 118 or other suitable apparatus may determine that the process tool is about to produce, or has begun producing, effluent. For example, interface eight 118 may receive a signal from sensor 144 which indicates that effluent is flowing through vacuum line 110. In another embodiment, interface 118 may receive a signal from process tool 102 which indicates that the process tool 102 is producing effluent. In still another embodiment, interface 118 may receive information from a database which indicates that the process tool 102 is producing effluent. Upon determining the process tool 102 is producing, or is about to produce, effluent, abatement tool 106 may be placed in an operational mode. This step may be effected by the interface 118 which may issue a command, or instructions, which places the abatement tool 106 in the operational mode.

The method ends in step 208.

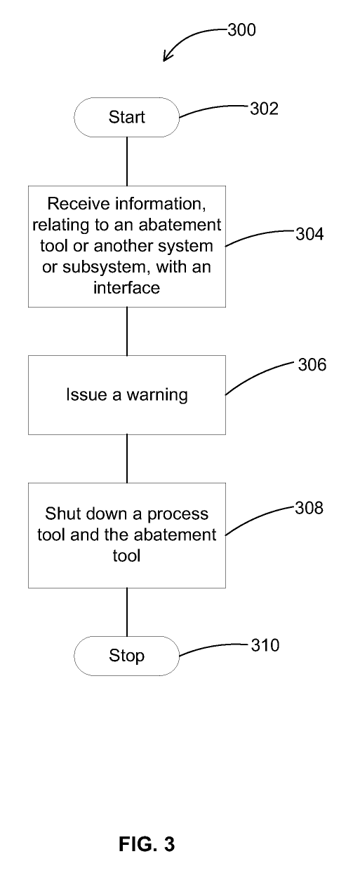

FIG. 3 is a flowchart depicting a method of adjusting an electronic device manufacturing system in accordance with the present invention. The method 300 begins with step 302.

In step 304, the interface 118 receives information relating to an abatement tool. The interface 118 may receive various types of information, such as, for example, that the abatement tool 106 has become starved of an abatement resource, that the abatement tool 106 is receiving an over abundance of an abatement resource, that the abatement tool 106 is receiving an improper effluent or an unexpected abatement resource, and/or that the abatement tool 106 may be experiencing an operating parameter which is outside of its design envelope, e.g., a temperature or pressure which is too high or too low, a loss of electricity, a loss of flame, etc. In such cases, a hazardous or unacceptably ineffective abatement condition may arise.

In step 306, the interface 118 may issue a warning. This step is optional, and the method may pass directly from step 304 to step 308. In fact, in some circumstances a fault may be critical and there may be no time to issue a warning. The warning may be issued to a controller, or a human operator, so that the controller or the human operator may attempt to rectify the condition which has caused the warning. The warning may be displayed on a computer monitor, or may be indicated by a warning light or a warning sound, etc. Any other suitable warning may be employed.

In step 308, the process tool and to the abatement tool are shut down in response to the interface receiving the information. In one embodiment, the interface 118 may issue commands which shut down the process tool and the abatement tool.

The foregoing description discloses only exemplary embodiments of the invention. Modifications of the above disclosed apparatus and method which fall within the scope of the invention will be readily apparent to those of ordinary skill in the art. For instance, the interface may be included in the electronic device manufacturing tool wherein the abatement system is communicatively coupled with the electronic device manufacturing tool to acquire the information related to the effluent.

Accordingly, while the present invention has been disclosed in connection with exemplary embodiments thereof, it should be understood that other embodiments may fall within the spirit and scope of the invention, as defined by the following claims.

What is claimed is:

1. A method of operating an electronic device manufacturing system comprising:
receiving information with an interface, wherein the information relates to an abatement system; and
shutting down a process tool and an abatement tool in response to the information.

2. The method of claim one wherein the information relates to a fuel flow.

3. The method of claim 1 wherein the information relates to a reagent flow.

4. The method of claim 1 wherein the information relates to a coolant flow.

5. The method of claim 1 wherein the information relates to a dangerous or unacceptably ineffective abatement condition.

6. The method of claim 1 wherein the information relates to a temperature of the abatement tool.

7. The method of claim 1 wherein the information relates to a pressure of the abatement tool.

8. The method of claim 1 wherein the information relates to the abatement tool receiving at least one of an effluent and an abatement resource, wherein the receipt creates a dangerous or unacceptably ineffective abatement condition.

9. The method of claim 1 wherein the interface causes the process tool and the abatement tool to be shut down.

10. A method of operating an electronic device manufacturing system comprising:
receiving information with an interface, wherein the information relates to an electronic device process tool; and
placing an abatement tool in an idle mode in response to the information.

11. The method of claim 10 wherein the information further relates to whether the electronic device process tool is generating effluent.

12. The method of claim 10 wherein the interface receives the information from a sensor adapted to measure an effluent flow.

13. The method of claim 10 wherein the information comprises an operating schedule for the electronic device process tool.

14. The method of claim 10 wherein the interface receives the information from a sensor adapted to measure an effluent composition.

15. An electronic device manufacturing system comprising:
an electronic device manufacturing process tool;
an abatement tool adapted to abate effluent from the electronic device manufacturing process tool;
an abatement resource supply adapted to supply an abatement resource to the abatement tool;
a sensor adapted to measure at least one of a flow of the abatement resource to the abatement tool and an operating parameter of the abatement tool; and
an interface adapted to receive information from the flow sensor, wherein the information comprises a rate of flow of the abatement resource.

16. The electronic device manufacturing system of claim further comprising a warning device.

17. The electronic device manufacturing system of claim wherein the electronic device manufacturing process tool is adapted to be shut down by the interface.

18. The electronic device manufacturing system of claim wherein the sensor is adapted to measure at least one of temperature, pressure, flame presence, and electrical power within the abatement tool.

19. The electronic device manufacturing system of claim wherein the sensor is adapted to measure the flow of the abatement resource.
